(19) United States
(12) Patent Application Publication
(10) Pub. No.: US 2003/0049426 A1
(43) Pub. Date: Mar. 13, 2003

(54) Friction material

(75) Inventors: Masaaki Kobayashi, Tokoname-shi (JP); Naoki Odani, Nagoya-shi (JP); Yasuo Futamura, Aichi-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AISIN SEIKI KABUSHIKI KAISHA, Kariya-shi (JP)

(21) Appl. No.: 10/170,689

(22) Filed: Jun. 14, 2002

(30) Foreign Application Priority Data
Jun. 14, 2001 (JP) 2001-179979

(51) Int. Cl. B32B 27/04

(52) U.S. Cl. 428/292.1; 428/297.4; 428/299.1

(57) ABSTRACT

A friction material includes a base material fiber, a binder, and a friction regulator. The base material fiber includes extremely-short aramid fiber with 1 mm or less length and short aramid fiber with over 1 mm length. By compounding the extremely-short aramid fiber with 1 mm or less length, a brake squealing of the friction material being obtained can be decreased.

This application is based on and claims priority under 35 U.S.C.§ 119 with respect to Japanese Application No. 2001-179979 filed on Jun. 14, 2001, the entire content of which is incorporated herein by reference.

### FIELD OF THE INVENTION

This invention generally relates to a friction material used in a brake for a vehicle. More particularly, the present invention pertains to a non-asbestos friction material that can prevent an abnormal noise and squealing of a brake.

### BACKGROUND OF THE INVENTION

For a known friction material used in a brake pad for a vehicle, a strong braking force, a high friction resistance, a small aggression against a corresponding part and no incidence of squealing are required.

Due to environmental concerns of recent years, a non-asbestos material is more likely to be used as a base material. Nowadays, semi-metallic for which steal fiber is used as the base material and non-asbestos for which such as aramid fiber is used as the base material are mainly used for the friction material. For the friction material for the vehicle, the non-asbestos is especially used because of its small aggression against the corresponding part and a high performance against squealing.

For a known non-asbestos friction material, aramid pulp in which aramid fascicle is partially dissociated in an axial direction is used instead of asbestos. An end portion of the aramid pulp is further fibrillated in fine forms and intertwined in the pad, which provides a strength and abrasion resistance. The aramid pulp does not only have a feature to maintain the strength of the friction material but also obtains the excellent abrasion resistance. On the other hand, however, the aramid pulp is a cause of the incidence of squealing when braking.

Thus, a need exists for a friction material which can maintain the strength of the brake pad and decrease the brake squealing in view of the above characteristics of the aramid fiber.

### SUMMARY OF THE INVENTION

According to the present invention, a friction material includes a base material fiber, a binder, and a friction regulator. The base material fiber includes extremely-short aramid fiber with 1 mm or less length and short aramid fiber with over 1 mm length. By compounding the extremely-short aramid fiber with 1 mm or less length, a brake squealing of the friction material being obtained can be decreased.

A content of the extremely-short aramaid fiber is preferably 5 to 60% by volume, and a content of the short aramid fiber is preferably 20 to 55% by volume relative to 100% by volume of the total base material fiber. By this composition ratio, the strength decrease of the friction material being obtained can be limited and the effect to decrease the brake squealing can be obtained.

A total volume of the extremely-short aramid fiber and the short aramid fiber is preferably 50% or more relative to 100% by volume of the total base material fiber. This composition ratio is for making good use of characteristics of the aramaid fiber as the base material fiber.

The content of the extremely-short aramid fiber is preferably 50% or less by volume relative to 100% of the total volume of the extremely-short aramid fiber and the short aramid fiber. This composition ratio is for limiting the strength decrease of the friction material being obtained as much as possible and also obtaining the effect to reduce squealing of the brake.

A length of the short aramid fiber is preferably in a range from over 1 mm to 6 mm maximum. If the length of the short aramid fiber is longer, the equal combining is more difficult.

The base material fiber includes inorganic fiber other than the aramid fiber and the inorganic fiber is at least one of potassium titanate fiber, copper fiber, carbon fiber, and glass fiber. This composition is for reflecting characteristics of the base material fiber to be compounded on the friction material.

For the binder, phenol resin or imido resin can be available.

For the friction regulator, inorganic barium sulfate, calcium carbonate, calcium hydroxide, mica, kaoline, and talc and organic cashew dust, and rubber dust can be available. Copper, brass, zinc, and iron oxide can be available as metal powder. Graphite, antimony trisulfide, molybdenum disulfide, and zinc disulfide can be available as lubricant. Silica, alumina, silicon carbide, zirconium oxide, and zirconium silicate can be available as inorganic oxide powder.

The friction material having the above-mentioned condition can maintain the strength of the brake pad. Moreover, an abrasion on a frictional face of the brake pad can be equalized and a partially uneven abrasion is not likely to occur. Further, a torque fluctuation is reduced and the incidence of squealing can be decreased.

The friction material is produced in the same Manner as the known non-asbestos by placing a mixed raw material of the base material fiber, the binder, the friction regulator and the like into a mold to be molded with heat under pressure applied.

### DETAILED DESCRIPTION OF THE INVENTION

An embodiment of the present invention will be explained referring to Examples 1-6 prepared to perform various tests. In Examples, a length and a compounding ratio of aramid fiber in a base material fiber of a friction material are varied for specifically evaluating a pad strength of the friction material and squealing of a brake. A test method and a test result will be explained as follows.

### EXAMPLE 1

A mixture of 4.5% by volume of extremely-short aramid fiber (1 mm of fiber length), 10.5% by volume of short aramid fiber (2.4 mm of fiber length), 15% by volume of cashew dust, 20% by volume of phenol resin, 10% by volume of potassium titanate, 30% by volume of barium sulfate, 5% by volume of graphite, 3% by volume of copper fiber, and 2% by volume of zirconium silicate was combined by an EIRICH mixer for 2 to 5 minutes at a speed of 2,000 to 3,000 rpm of a chopper and 64 rpm of a pan. This mixture was placed into a mold with 150 to 200 degree and cooled with heat under a pressure of 20 to 50 MPa for 5 to 10 minutes. After molding, the mixture was placed into a furnace to be heated at 200 to 250 degree for 8 to 16 hours.

### EXAMPLE 2

Instead of the extremely-short aramid fiber with 1 mm length shown in Example 1, the extremely-short aramid fiber with 0.5 mm length was used. A composition and a producing method of the mixture were same as those of Example 1.

### EXAMPLE 3

Instead of the extremely-short aramid fiber and the short aramid fiber shown in Example 1, 7.5% by volume of the extremely-short aramid fiber (0.5 mm of fiber length) and 7.5% by volume of the short aramid fiber (2.4 mm of fiber length) were compounded. The composition and the producing method of the mixture were same as those of Example 1.

### EXAMPLE 4

Instead of the extremely-short aramid fiber and the short aramid fiber shown in Example 1, 15% by volume of the extremely-short aramid fiber (1 mm of fiber length) was compounded. The composition and the producing method of the mixture were same as those of Example 1.

### EXAMPLE 5

Instead of the extremely-short- aramid fiber and the short aramid fiber shown in Example 1, 10.5% by volume of the extremely-short aramid fiber (0.5 mm of fiber length) and 4.5% by volume of the short aramid fiber (2.4 mm of fiber length) were compounded. The composition and the producing method of the mixture were same as those of Example 1.

### EXAMPLE 6

Instead of the extremely-short aramid fiber and the short aramid fiber shown in Example 1, 15% by volume of the short aramid fiber (2.4 mm of fiber length) was compounded. The composition and the producing method of the mixture were same as those of Example 1.

The compounding ratio of the friction materials of the above Examples 1-6 is shown in Table 1.

TABLE 1

| | Ex. 1 | Ex. 2 | Ex. 3 | Ex. 4 | Ex. 5 | Ex. 6 |
|---|---|---|---|---|---|---|
| Length of extremely-short | 1.0 | 0.5 | 0.5 | 1.0 | 0.5 | — |
| aramid fiber (mm) | | | | | | |
| Compounding ratio of | 4.5 | 4.5 | 7.5 | 15.0 | 10.5 | 0.0 |
| extremely-short aramid fiber | | | | | | |
| (% by volume) | | | | | | |
| Compounding ratio of short | 10.5 | 10.5 | 7.5 | 0.0 | 4.5 | 15.0 |
| aramid fiber (% by volume) | | | | | | |
| Compounding ratio of cashew | 15.0 | 15.0 | 15.0 | 15.0 | 15.0 | 15.0 |
| dust (% by volume) | | | | | | |
| Compounding ratio of phenol | 20.0 | 20.0 | 20.0 | 20.0 | 20.0 | 20.0 |
| resin (% by volume) | | | | | | |
| Compounding ratio of | 10.0 | 10.0 | 10.0 | 10.0 | 10.0 | 10.0 |
| potassium titanate (% by | | | | | | |
| volume) | | | | | | |
| Compounding ratio of barium | 30.0 | 30.0 | 30.0 | 30.0 | 30.0 | 30.0 |
| sulfate (% by volume) | | | | | | |
| Compounding ratio of | 5.0 | 5.0 | 5.0 | 5.0 | 5.0 | 5.0 |
| graphite (% by volume) | | | | | | |
| Compounding ratio of copper | 3.0 | 3.0 | 3.0 | 3.0 | 3.0 | 3.0 |
| fiber (% by volume) | | | | | | |
| Compounding ratio of | 2.0 | 2.0 | 2.0 | 2.0 | 2.0 | 2.0 |
| zirconium silicate (% by | | | | | | |
| volume) | | | | | | |

A friction test was performed on the friction materials of the above Examples 1-6. For this test, an inertia friction and abrasion testing machine was used. A disk on a rotating side is FC200 and its surface roughness is 2.0Z or less. The test was performed under the condition that a sliding radius is 32 mm, a wind speed is 11 m/s, inertia is 0.25 kg·m², a dimension of each friction material is 3.9 cm², a disc temperature before engaging is 120 degree, a pushing load is 400N, engaging frequency is 1000, and a peripheral velocity is 1-6 m/s.

Following items were evaluated for the friction materials of the above-mentioned embodiment and comparative examples on which the friction test was performed.

Evaluation of Torque Fluctuation Deviation When Braking

A torque waveform was measured and evaluated based on a standard deviation as an index of a torque fluctuation data (80% or more of a target pushing pressure) during 1 engaging being sampled within 50 msec. Determination of the torque fluctuation was conducted in three levels of ◯: the fluctuation deviation is 1 or less and the hysteresis fluctuation is small, Δ: the fluctuation deviation is over 1 and the hysteresis fluctuation is small, and X: the hysteresis fluctuation is large.

Evaluation of Changing Ratio of Fiber Dimension

With regard to the aramid existence condition on the frictional face of the pad, ten views based on a center portion of the frictional face were observed through a fluorescent microscope (100 magnifications) by ultraviolet irradiation. The aramid existence ratio was evaluated by an image processing.

Evaluation of Pad Strength

A shear strength of the pad was tested based on JIS-D4415. Determination of the pad strength was conducted in three levels of ◯: the shear strength is 4 MPa or more, Δ: the shear strength is 3 to 4 MPa, and X: the shear strength is 3 MPa or less.

Evaluation of Squealing of Actual Vehicle

The friction materials of the above-mentioned embodiment and the comparative examples were mounted in the actual vehicle and break-in was performed based on JASO-C402. The incidence of the brake squealing was checked with a combination of a vehicle speed of 20 to 130 K/m, an acceleration of 1.96 m/sec² to 7.84 m/sec², and a pad temperature of 60 to 200 degree.

The length of the extremely-short aramid fiber of each friction material, the compounding ratio of the extremely-short aramid fiber relative to a total aramid fiber, and performance evaluation results are shown in Table 2.

TABLE 2

| | Ex. 1 | Ex. 2 | Ex. 3 | Ex. 4 | Ex. 5 | Ex. 6 |
|---|---|---|---|---|---|---|
| Length of extremely-short | 1.0 | 0.5 | 0.5 | 1.0 | 0.5 | — |
| aramid fiber (mm) | | | | | | |
| Compounding ratio of | 4.5 | 4.5 | 7.5 | 15.0 | 10.5 | 0.0 |
| extremely-short aramid fiber | | | | | | |
| relative to total base material | | | | | | |
| fiber (% by volume) | | | | | | |
| Compounding ratio of | 30 | 30 | 50 | 100 | 70 | 0.0 |
| extremely-short aramid fiber | | | | | | |
| relative to total aramid fiber | | | | | | |
| (% by volume) | | | | | | |
| Pad strength | ◯ | ◯ | ◯ | X | X | ◯ |
| Changing ratio of fiber | 1.16 | 1.10 | 1.04 | 0.98 | 1.05 | 2.23 |
| dimension | | | | | | |
| Between 50^{th} and 1,000^{th} | | | | | | |
| time of braking | | | | | | |
| Torque fluctuation deviation | | | | | | |
| with 1 braking | | | | | | |
| 50^{th} time of braking | 0.50 | 0.37 | 0.42 | 0.24 | 0.39 | 1.25 |
| 100^{th} time of braking | 0.83 | 0.66 | 0.51 | 0.31 | 0.48 | 2.91 |
| Determination | ◯ | ◯ | ◯ | ◯ | ◯ | X |
| Squealing of actual vehicle | None | None | None | None | None | Existed |

According to the evaluation result of the friction materials in Examples 1-3, in which the extremely-short aramid fiber with 1 mm or less length was compounded 5 to 60% by volume relative to the total volume of the base material fiber and was compounded 50% or less by volume relative to the total volume of the aramid fiber, the friction materials were able to maintain the strength of the brake pad. Moreover, the changing ratio of the fiber dimension was almost stable between the 50^{th} and the 1,000^{th} time of braking. Further, the torque fluctuation was reduced and the incidence of the brake squealing was decreased.

According to the evaluation result of the friction materials in Examples 4,5, in which the extremely-short aramid fiber with 1 mm or less length was compounded 5 to 60% by volume relative to the total volume of the base material fiber and was compounded over 50% relative to the total volume of the aramid fiber, the changing ration of the fiber dimension was almost stable between the 50^{th} and the 1,000^{th} time of braking. The abrasion of these friction materials was equalized, the torque fluctuation was, reduced, and the squealing of the brake was decreased. However, the pad strength was not sufficient.

According to the evaluation result of the friction material in Example 6, in which the extremely-short aramid fiber was not compounded and only the short aramid fiber with 2.4 mm length was compounded, the strength of the brake pad was maintained but the changing ratio of the fiber dimension was increased more than twice between the 50^{th} and the 1,000^{th} time of braking. The torque fluctuation was also increased and the squealing of the brake occurred.

Accordingly, as mentioned above, by specifying the fiber length of the aramid fiber in the base material fiber of the friction material and the compounding ratio of the aramid fiber, the friction material having a feature to maintain the strength of the brake pad and decrease the brake squealing can be available.

By compounding the extremely-short aramid fiber with 1 mm or less length and the short aramid fiber with over 1 mm length for the base material fiber, the friction material of this invention can maintain the strength of the brake pad and the torque fluctuation can be reduced due to the even abrasion. The incidence of the squealing of the brake can be decreased accordingly.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A friction material comprising:
a base material fiber;
a binder; and
a friction regulator; wherein the base material fiber includes extremely-short aramid fiber with 1 mm or less length and short aramid fiber with over 1 mm length:

2. A friction material according to claim 1, wherein:
a content of the extremely-short aramid fiber is 5 to 60% by volume and a content of the short aramid fiber is 20 to 55% by volume relative to 100% by volume of the total base material fiber:

3. A friction material according to claim 1, wherein:
a total volume of the extremely-short aramid fiber and the short aramid fiber is 50% or more relative to 100% by volume of the total base material fiber:

4. A friction material according to claim 1, wherein:
a content of the extremely-short aramid fiber is 50% or less by volume relative to 100% of the total volume of the extremely-short aramid fiber and the short aramid fiber:

5. A friction material according to claim 1-3, wherein:
a length of the short aramid fiber is in a range from over 1 mm to 6 mm maximum:

6. A friction material according to claim 1-3, wherein:
the base material fiber includes inorganic fiber. and the inorganic fiber is at least one of potassium titanate fiber, copper fiber, carbon fiber, and glass fiber:

7. A friction material according to claim 1, wherein:
the binder is phenol resin or imido resin:

8. A friction material according to claim 1, wherein: the friction regulator is at least one of barium sulfate, calcium carbonate, calcium hydroxide, mica, kaolin, talc, cashew dust, rubber dust, copper, brass, zinc, iron oxide, graphite, antimony trisulfide, molybdenum disulfide, zinc disulfide, silica, alumina, silicon carbide, zirconium oxide, and zirconium silicate.
